(19) United States
(12) Patent Application Publication
(10) Pub. No.: US 2007/0136179 A1
(43) Pub. Date: Jun. 14, 2007

(54) System & method for providing reverse auction services

(75) Inventor: Kiet Vat Nguyen, Hayward, CA (US)

Correspondence Address: Stephen R. Uriarte, Ste. 100, 257 Rodonovan Drive, Santa Clara, CA, 95051, US

(73) Assignee: Toolow, Inc., a Delaware Corporation

(21) Appl. No.: 11/304,230

(22) Filed: Dec. 14, 2005

(51) Int. Cl. G06Q 40/00

(52) U.S. Cl. 705/37; 705/38

(57) ABSTRACT

Reverse auction services are provided by processing a user logon request. If the user selects a buy transaction, these reverse auction services include providing a buy transaction service to the user. If the user selects a sell transaction, these reverse auction services include a sell transaction service. The buy transaction service includes permitting the user to submit a buy transaction without entering an initial bid price. In another example, the sell transaction service may include using a user interface having a bid price field for receiving a pricing format that includes a non-realized value portion. In a further example, the pricing format may further include a realized value portion. In yet another further example, a user who has previously submitted a buy transaction that is currently pending may cancel that buy transaction even if a valid bid has been submitted for the buy transaction.

### FIELD OF THE INVENTION

The present invention generally pertains to the electronic commerce field. More specifically, the present invention pertains to improved systems and methods for providing reverse auctions.

### BRIEF DESCRIPTION OF THE DRAWINGS

The accompanying drawings, which are incorporated in and form a part of this specification, illustrate embodiments of the present invention and, together with the description, serve to explain the principles of the invention.

FIG. 1 is a block diagram of a computer platform for providing reverse auction services in accordance with a one embodiment of the present invention.

FIG. 2 is a block diagram of various records and fields associated with databases used in accordance with another embodiment of the present invention.

FIG. 3 is a block diagram of a process for providing reverse auction services in accordance with yet another embodiment of the present invention.

FIG. 4 is a block diagram describing a process for initiating a reverse auction session in accordance with yet another embodiment of the present invention.

FIG. 5 is a block diagram describing a process for performing a buy transaction in a reverse auction in accordance with yet another embodiment of the present invention.

FIG. 6 is a user interface for searching items which may be selected for a buy transaction in accordance with another embodiment of the present invention.

FIG. 7 is a user interface for defining and submitting a buy transaction in a reverse auction in accordance with another embodiment of the present invention.

FIG. 8 is a block diagram describing a process for performing a sell transaction in a reverse auction in accordance with yet another embodiment of the present invention.

FIG. 9 is a user interface for selecting an item, which is subject to a pending buy transaction, for bid in a reverse auction in accordance with another embodiment of the present invention.

FIG. 10 is a block diagram describing a process for performing a bid transaction in a reverse auction in accordance with yet another embodiment of the present invention.

FIG. 11 is an example user interface for defining and submitting a bid transaction in a reverse auction in accordance with another embodiment of the present invention.

FIG. 12 is a block diagram describing a process for processing a bid transaction in a reverse auction in accordance with yet another embodiment of the present invention.

FIG. 13 is a block diagram describing a process for accepting or rejecting a bid submitted for a buy transaction in accordance with yet another embodiment of the present invention.

FIG. 14 is a user interface that lists pending buy transactions that have respectively received at least one valid bid in accordance with yet further another embodiment of the present invention.

FIG. 15 is a user interface for listing at least one valid bid that has been submitted for a pending buy transaction in accordance with another embodiment of the present invention.

### DETAILED DESCRIPTION OF THE PREFERRED EMBODIMENTS

In the following detailed description, for purposes of explanation, numerous specific details are set forth in order to provide a thorough understanding of the present invention. However, it will be apparent to those skilled in the art that the present invention may be practiced without these specific details. In addition, after perusal of this application, those skilled in the art would recognize that the processes, data structures and functions described herein may be implemented by using a general purpose computer and program code and other well-known devices known in the computer, networking and program fields.

The various embodiments of the present invention described below are directed to the use of a machine- or computer-enabled reverse auction electronic commerce system, which may be further configured to use complex pricing. The term “complex pricing” represents a pricing format that has at least two portions, which may be used separately or in combination with each other. The first portion represents a “realized portion”, while the second portion represents a “non-realized” portion. The term “realized portion” represents a value that a user, such as a seller, is willing to receive immediately from or give to another user, such as a buyer, upon the successful completion of a buy transaction. This value may either be positive, negative or zero and may be paid in the form of cash, bank draft (such as a check), money order or payment made by a third party on the payor's behalf, such as a credit card company or bank.

The term “buy transaction” is defined herein to include an offer by a user to purchase, obtain or perform an item from or for another user in a reverse auction process as taught by the various embodiments of the present invention disclosed herein. A successful reverse auction is defined as a reverse auction where the buyer submits a buy transaction for an item and accepts a bid for that item from a seller while that buy transaction is still pending. The term “pending buy transaction” is defined herein as a buy transaction submitted by a buyer which has not expired, or has been accepted or cancelled by the buyer. When submitting a buy transaction, the submitting user is neither required to include an initial bid price nor required to accept any bid submitted for the pending buy transaction, even if the submitted bid is valid.

The term “non-realized” represents a value that the user of the complex pricing format intends to provide or receive but the value is not immediately available to the user to provide or receive. For example, the unrealized value may be used to represent any unrealized value, such as a loan, or an unrealized cost, such as an opportunity cost. Some examples of opportunity cost include pollution, wasted time, noise, resource scarcity, real estate scarcity and the like.

The complex pricing format may be expressed using the following syntax.
Complex Price=+a+(bi+cj+dk+el+fm+ . . . )
The symbol a represents the realized portion, while the symbols in the parentheses represent the non-realized portion of the complex price.

When used in a reverse auction context, if the realized portion, a, is positive, it represents a value, such as U.S. dollars, that a user such as a buyer is willing to pay another user, such as a seller, for an item under bid. If negative, the realized portion represents what the buyer would be willing to receive from a seller of the item. In addition, the realized portion is an immediate value, meaning it is immediately due to seller if positive, or to buyer if negative, upon achieving a successful a reverse auction.

The seller in a reverse auction may also use the non-realized portion of the complex pricing as a value in a buy transaction either in combination with the realized portion or separately from the realized portion. As shown above, the non-realized portion may be expressed using the following syntax:
bi+cj+dk+el+fm+ . . . ,
where b, c, d, e, f . . . represent variables having positive, negative or zero values, the symbol i indicates that the variable b is a loan value, the symbol j indicates that the variable c is an interest rate, the symbol k indicates that d is the time period for the loan indicated by the symbol i, the symbol l indicates that e is the value of a selected opportunity cost, and the symbol m indicates that f is the value of another selected opportunity cost.

In one embodiment of the present invention, d is expressed in the form of days per year multiplied by the number of years, if the loan period is equal to or more than one year. If the loan period is less than the one year, then d is expressed in days.

In another embodiment of the present invention, e represents the scarcity of the item under bid in U.S. dollars when combined with the symbol l and f represents the pollution cost that arises from the manufacture of the item under bid in U.S. dollars when combined with the symbol m. Additional opportunity cost values, such as wasted time, noise, real estate scarcity and the like, may be further included with the non-realized portion as indicated by the ellipsis symbol “ . . . ”, but are not shown to avoid overcomplicating the herein disclosure. The symbols i, j, k, l and m hereinafter referred to as pricing vectors and, when combined with their respective variables, are referred to as pricing vector pairs. In accordance with one embodiment of the present invention, a user, such as buyer or seller, may use none, or any one or combination, of the pricing vector pairs when entering a price during a reverse auction.

The following paragraphs provided various examples of using complex pricing in reverse auctions. In one example, a buyer may be willing to receive items, such as email advertisements, marketing materials for an item, trash and the like, from a seller in return for receiving something of immediate value, such as U.S. dollars, from the seller. The amount of the value sought by the buyer in this buy transaction would be expressed in the buyer's bid as a negative realized portion, such as negative five dollars (−$5.00), and may be generally expressed as −a. This negative realized portion signifies two things. The negative sign symbol “−” signifies that the winning seller is the party that would immediately pay the buyer upon close of a successful bid by the seller. The amount of payment by the seller would be the absolute value of the negative realized portion, which in this example is five dollars ($5.00). Upon payment, the seller would then be free to send the buyer an amount of email advertisements that the buyer is willing to receive under the bid.

In another example, if a buyer uses a zero value (i.e., “0”) for the realized portion in a buy transaction, the zero value represents an intention by the buyer that the buyer seeks to receive the item without cost to either the buyer or the winning seller.

In yet another example, a seller may make a bid to sell an item for a price of $5.00 dollars in response to a pending buy transaction. The seller's bid may be expressed in a complex pricing format as a positive realized portion, such as positive five dollars (“5.00”), and may be generally expressed as a. This positive realized portion of positive five dollars signifies the amount that the seller is willing to receive from the buyer for the pending buy transaction.

In a further example, a buyer may wish to purchase a certain item, such as food, but does not have enough money on-hand. Consequently, the buyer may wish to place a buy transaction to purchase food and receives from a seller a bid that uses both realized and non-realized pricing, which may be expressed generally as a+bi, where a represents the amount of money that the seller seeks to receive immediately and +bi represents the remaining balance that the seller is willing to be owed by the buyer upon the close of a successful bid. This form of complex pricing may be entered as 5+$5i if the seller seeks to receive $5 dollars immediately and to be owed a $5 balance upon acceptance of seller's bid by the buyer. Since the pricing vector pair of cj is not included in the non-realized portion, the seller does not intend to seek interest for the balance owed.

In a variation of the above example, a buyer may wish to characterize the unpaid balance as a loan with interest over a fixed time period, which would result in a complex pricing format that may be generally expressed as: +a+bi+cj+dk. In this example, this form of complex pricing may be entered as $5+$5i+8j+(365*2)k, if the buyer seeks to pay the balance due of five dollars ($5.00) over two years at eight percent (8%) interest.

In yet another example, a user may wish to use a complex pricing format of −a+bi, such as when a seller wishes to bid for an item subject to a pending buy transaction but seeks to be paid by the buyer a certain amount immediately, and to be owed by the buyer a certain value without interest payments. For example, a buyer may place a buy transaction that offers to pick-up trash for $60 dollars. However, the seller pays buyer $100, resulting in an overpayment of $40, which the seller is willing to define as a loan amount payable without interest. This scenario may occur if the seller only has a $100 dollar bill and the buyer does not have sufficient change to provide the $40 overpayment.

In a variation of the above example, the buyer may wish to perform a certain act for compensation, such as retrieving trash, but the bidding seller wishes to compensate buyer using complex pricing. The seller would bid using a complex pricing format that is generally expressed as: −a−bi. For example, if the seller wishes to accept a buy transaction from a buyer where the buyer seeks to be paid $60 to pick-up trash, the seller may bid using the complex pricing: −20+40i, which represents the seller's intention of both paying the buyer $20 and owing the buyer $40 without interest if the seller's bid is accepted by the buyer.

The term “item” is intend to include any good, service or a combination of both, that may be obtained, purchased, or performed by a buyer, or sold or provided by a seller in a reverse auction.

In yet another example, the complex pricing format may be used where a seller wishes to receive a certain payment amount from a buyer and also provide the buyer with a mail-in rebate amount payable within 6 months of rebate submission with a five percent interest rate on the rebate amount. This complex pricing would be expressed using the following expression: +a−bi+cj+dk, where a is equal to the dollar amount payable to seller by buyer, b is equal to the rebate amount; c is equal to the interest rate; and d is equal to the applicable period in which the interest rate applies. In accordance with another embodiment of the present invention, the complex pricing format disclosed above may be implemented with the various embodiments of the present invention disclosed herein.

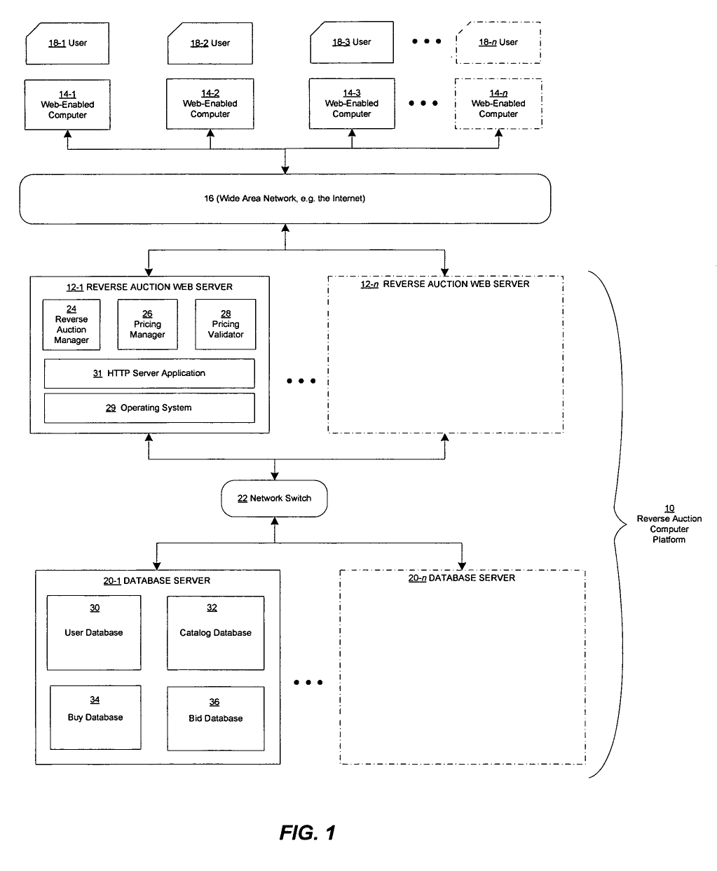

Referring now to FIG. 1, a computer platform 10 includes a single server or a cluster of servers, such as servers 12-1 through 12-n, for providing auction website services to web-enabled computers, such as 14-1 through 14-n, that connect to computer platform 10 via a wide area network 16, such as the Internet, when used by users 18-1 through 18-n. The term “web-enabled” computer is intended to include any personal or general purpose computer having an operating system, such as Linux, Windows XP and the like; at least one web-browser, such as the Windows Internet Explorer or Mozilla's Firefox browser; and a network interface for enabling the web-enabled computer to access network 16. This network interface may include a TCP-IP adapter for connecting to a gateway or modem, which are not shown. When connected to computer platform 10 via network 16, web-enabled computers 14- 14-n, function as client devices that permit users 18-1 through 18-n to interact and receive on-line reverse auction services from computer platform 10.

Servers 12-1 through 12-n are connected to a single database server or a cluster of database servers 20-1 through 20-n through a network switch 22 or equivalent device that will permit the servers and database servers to communicate and transfer data between or among each other. Having a cluster of servers and database servers is not intended to limit the present invention. One or more servers or database servers may be used, depending on whether load balancing, redundancy or both are required. In addition, if computer platform 10 is limited to a single server 12-1 and a single database server 20-1, they may be connected to each other directly, eliminating the need for switch 20.

Each server, such as 12-1, provides reverse auction website services through the use of various programming or scripting modules, including a reverse auction manager 24, pricing manager 26 and pricing validator 28. Each server also includes an operating system 29 and http web server application 31. In the example shown, reverse auction manager 24, pricing manager 26, pricing validator 28 and user interfaces used by them, such as webpages, may be implemented using the PHP scripting language, hyper-text mark up language, commonly referred to as HTML, and java script.

Operating system 29 may be implemented using any operating system, such as Mandriva Linux, formerly known as Mandrake Linux, or operating systems available from Microsoft of Redmond, Wash., such as Windows 2003 server. Http web server application 31 may be implemented using any http server application program that can deliver webpages using the http protocol and that is compatible with the operating system selected. One http web server application is available from Apache, which is an open source http web server application available from the Apache Software Foundation or from Microsoft, using the Internet Information Server, which is bundled with Windows 2003 Server and which is commonly referred to as IIS.

The use of the PHP scripting language, Apache web server application and Mandriva Linux is not intended to limit the present invention any way. Other types of scripting or programming languages, http web server applications and operating systems may be used. For example, ASP, Ajax, Java, Python, Perl, Shell, C, C#, Assembly, Ruby, Cold Fusion are other types of computer programming or scripting languages that may be used to implement reverse auction manager 24, pricing manager 26, pricing validator 28 and the webpages described herein. The PHP scripting language, Apache http server application, and Mandriva Linux operating system may be obtained as a software distribution from Mandriva of San Diego, Calif. and for download at www.mandrivalinux.com.

Reverse auction manager 24 manages the website reverse auction services provided by computer platform 10. Pricing manager 26 enforces the pricing format used in the reverse auction. In one embodiment of the present invention, pricing manager 26 reviews each price entered by a user during a bid transaction and ensures that the price entered complies with a selected pricing format, such as the complex pricing format taught using the various embodiments of the present invention, which are disclosed herein. The use of a complex pricing format is not intended to limit the scope and spirit of the various embodiments of the present invention disclosed. Instead, other types of pricing formats may be used, including a pricing format that solely uses a positive number for representing a selected currency.

Pricing validator 28 validates a proposed total bid price entered under a bid transaction by determining whether the proposed total bid price is less than or equal to the total of the previously submitted bid price minus any decrement value. The proposed total bid price, the previously submitted bid price and any decrement value pertain to the same buy transaction.

Each server or database server may be implemented using any general purpose computer hardware that has sufficient resources to provide the functionality described above. For example, server 12-1 may be implemented using a 1U rack-mounted general purpose server using the AMD Opteron CPU, 2 Gigabytes of RAM, 80 GB of mass storage in a mirrored configuration and a redundant power supply. Database server 20-1 may be similarly configured except that it may also be coupled to a network or array of mass storage devices (not shown). Using a network of mass storage devices provides data storage redundancy and scalability, as well as adequate physical storage to store data entered into user database 30, catalog database 32, buy database 34 and bid database 36.

User database 30, catalog database 32, buy database 34 and bid database 36 store various information received or generated by reverse auction manager 24, pricing manager 26 and pricing validator 28 during the provision of on-line auction services. These databases may be implemented using any type of database application but in the example shown are implemented as MySQL relational database applications, which are available from MySQL AB of Sweden and for download at www.mysql.com.

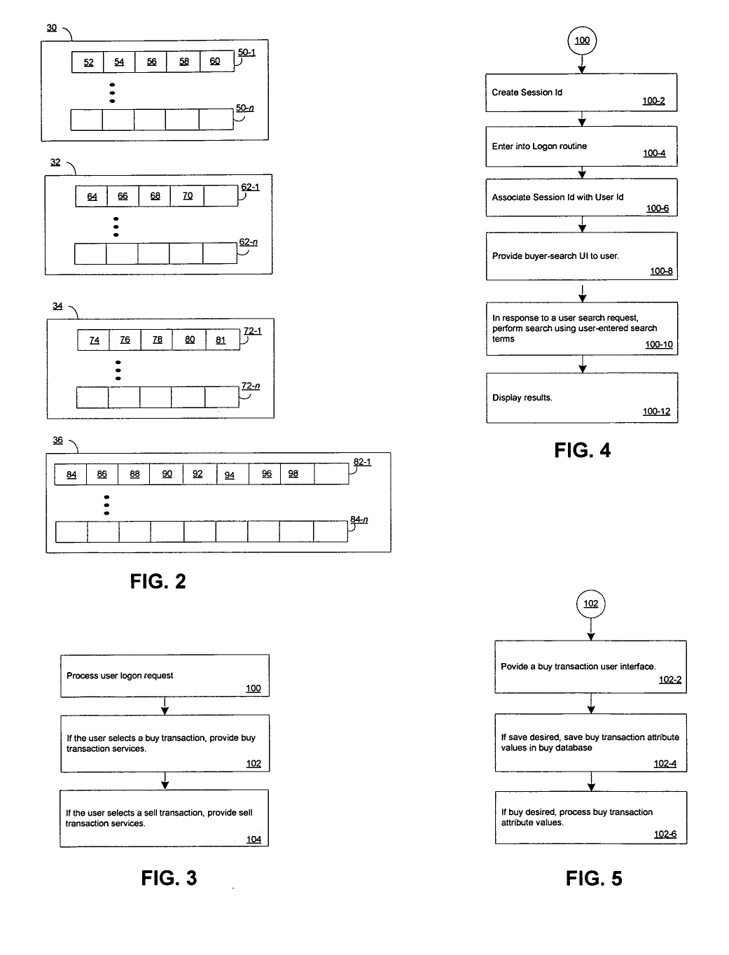

Referring now to FIG. 2, the various records and corresponding fields defined for user database 30, catalog database 32, buy database 34 and bid database 36 are shown. The implementation shown is not intended to limit the various embodiments described for the present invention but other types of implementations may be used that follow the described relationship between or among the data stored in these databases. For example tables, one large database or equivalent approaches may be used.

In FIG. 2 and in another example, user database 30 may be configured for storing information related to users who logon on to the reverse auction website. This information is hereinafter referred to as “user information” and may be stored in user database 30 in the form of a database record, hereinafter referred to as a “user record”. Each user record 50-1 through 50-n contains fields for storing the user information for each user who has successfully registered as a user of the on-line auction services described in the various embodiments of the present invention disclosed herein. Each user record created in database 30 may be defined to include the following fields: user id field 52, user name field 54, user contact field 56, password field 58 and session id field 60. In another embodiment of the present invention, session id field 60 may be omitted from the user record but be maintained using a table (not shown) for associating the session id with the user id stored in user id field 52.

Catalog database 32 is configured for storing to information that describes an item which a user may select for a buy transaction. This information is hereinafter referred to as “item information” and may be stored in catalog database 32 in the form of a database record, hereinafter referred to as an “item record”. Each item record 62-1 through 62-n includes the following fields: an item id field 64, an item title field 66 and an item description field 68. Item description field 68 is for storing technical and/or functional specifications, reviews and references of the item to which the item record corresponds. Item title field 66 is for storing the title of the item, which may be a description of a good or service. Item id field 64 is defined to hold a unique identifier for the item, hereinafter “item id”. This item id is generated by reverse auction manager 24.

Each item record 62 may also include a field for holding the average total bid price 70 accepted by a user in a success reverse auction completed for the item corresponding to the item information. Additional information (not shown), such as picture(s) of the item, questions and answers posted by users familiar with the item, and the like, may also be included in item record 62, if available or applicable.

Administrators of computer platform 10, users of the on-line reverse auction services provided by computer platform 10, or both select which items may be selected for a buy transaction. For each item selected, these administrators, users or both would enter the respective item information values, other than the item id, and save these item information values in corresponding fields of an item record, such as item record 62-1, created in catalog database 32.

Buy database 34 is configured for storing information related to buy transactions. This information is hereinafter referred to as “buy information”. As shown in FIG. 2, buy information may be stored in buy database 34 in the form of a database record, hereinafter referred to as a “buy record”. Each buy record, such as buy record 72-1 through 72-n, contains fields for storing information to be saved as buy information, which in this example, include the following fields: buy attribute field 74, buy id field 76, user id field 78 status field 80 and a bid id field 81.

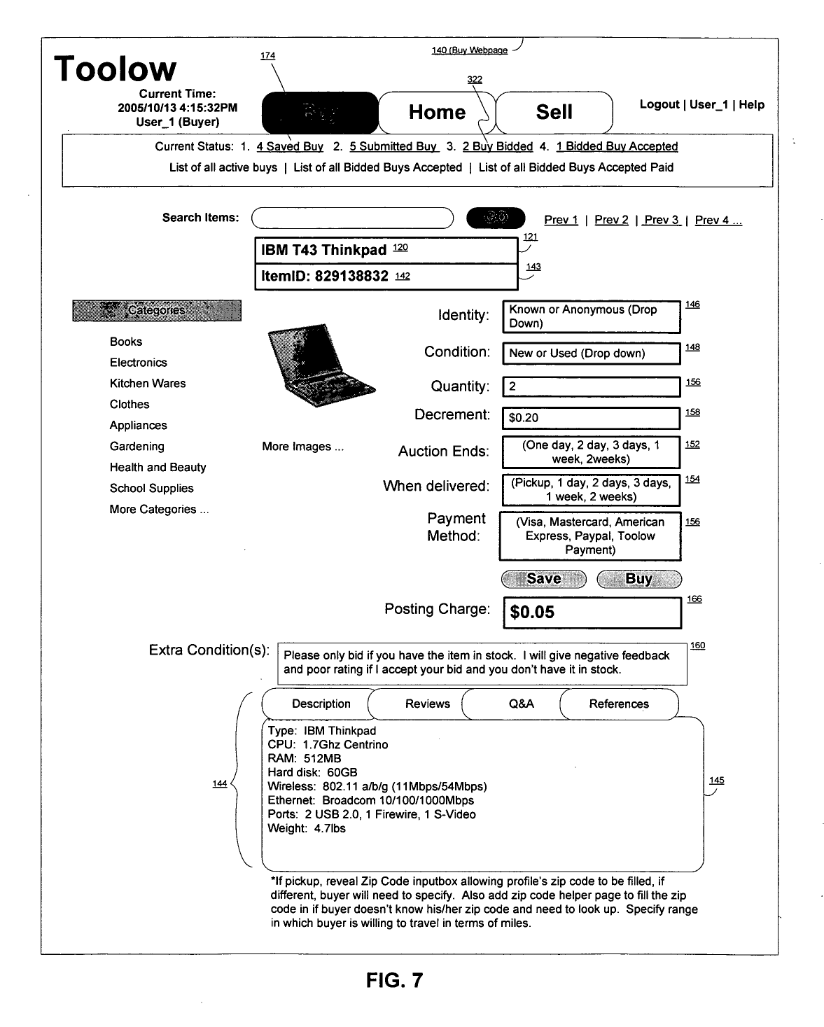

Buy attribute field 74 is for storing buy attribute values, which are received by reverse auction manager 24 through a user interface, such as buy webpage 140, which is discussed with reference to FIG. 7 below. Buy id field 76 is intended to store a buy id, which is a unique identifier for each buy transaction corresponding to the buy attribute values stored in buy record 72-1. User id field 78 is for storing a unique identifier corresponding to the user who provided the buy attribute values. The buy id and user id are generated by reverse auction manager 24. Status field 80 is for indicating the status of a buy transaction, including saved but not pending, pending, accepted, cancelled and expired.

Bid id field 81 is for storing a unique identifier, hereinafter a bid id, which corresponds to a bid record created to hold bid information entered by a seller during a bid transaction. In another embodiment of the present invention, bid id field 81 may be omitted from buy records 72-1 through 72-n but maintained in a table (not shown) for associating a bid id with a buy id stored in buy id field 76.

Bid database 36 is for storing information related to a bid submitted by a user in response to a pending buy transaction. This information is hereinafter referred to as “bid information”. As also shown in FIG. 2, bid information may be stored in bid database 36 in the form of a database record, hereinafter “bid record”. Each bid record, such as bid records 82-1 through 82-n, may include the following fields: bid id field 84, bid price field 86, shipping and handling field 88, tax field 90, other charges field 92, bid fee field 94, buy id field 96 and bid status field 98. A pending buy transaction is any buy transaction which has not yet expired or has been accepted or cancelled by the user who submitted the buy transaction.

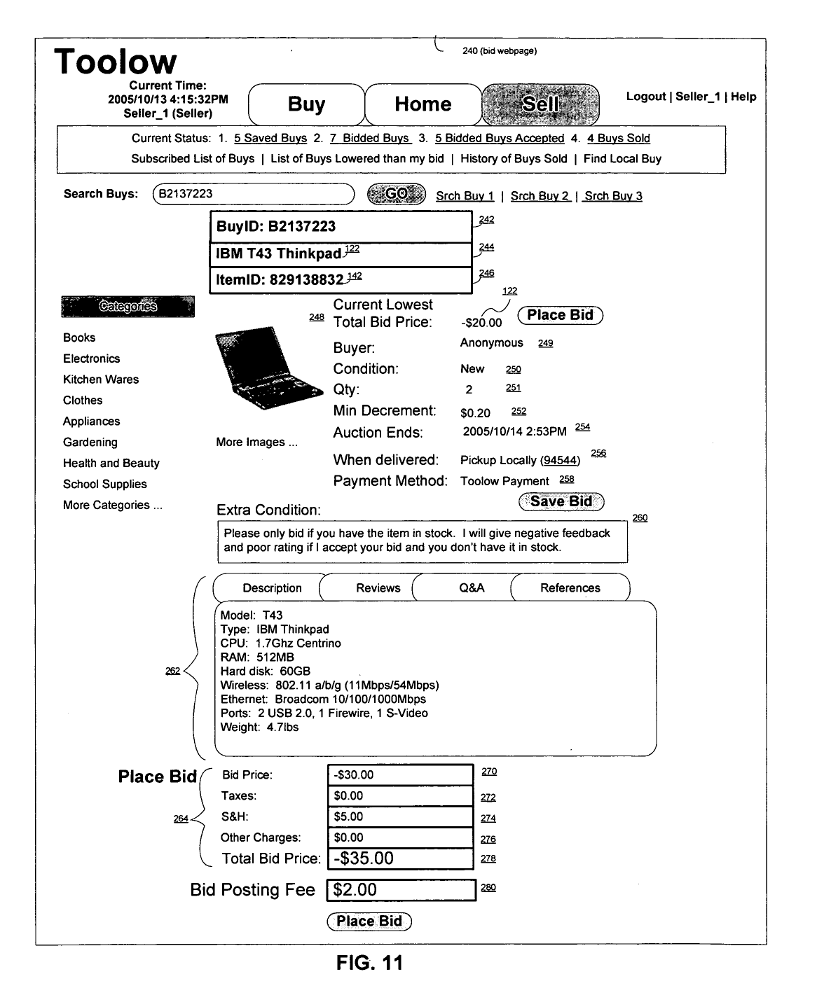

Bid id field 82 is for storing a bid id value, which is generated by reverse auction manager 24 and is a unique identifier for each submitted bid that has its bid information stored in bid database 36. Bid price field 84 is defined to hold a proposed total bid price, which is entered in a field provided by a user interface, such as bid price field 270 provided by webpage 240 as shown in FIG. 11 and discussed below. Buy id field 97 is for storing the buy id generated for the buy transaction to which the bid information corresponds. Including the buy id as part of the bid information, permits reverse auction manager 24 to link to the buy information to which the bid information pertains. Bid status field 98 is for storing a bid status, which is for indicating whether the bid transaction represented by the bid record is displayable to all users, or has been rejected or accepted by the user of the buy transaction to which the bid record pertains.

FIG. 3 is a block diagram showing the program flow in accordance with another embodiment of the present invention.

In response to a user logon request for reverse auction services, computer platform 10 through reverse auction manager 24 processes 100 the logon request.

If the user selects a buy transaction, reverse auction manager 24 provides 102 buy transaction services to the user. These buy transaction services include, but are not limited to, enabling the user to submit a buy transaction for an item without including an initial bid price. In addition, the user is not obligated to accept any bid submitted for the buy transaction.

If the user selects a sell transaction, reverse auction manager provides sell transaction services to the user.

FIG. 4 is a block diagram showing a process for initiating a reverse auction session, such as the reverse auction session disclosed above and in FIG. 3, in accordance with another embodiment of the present invention.

The reverse auction session is initiated by reverse auction manager 24 in response to an entry by a user, such as user 18-1, of a network address or domain name corresponding to computer platform 10. In response to the entry, reverse auction manager 24 causes a logon webpage to be displayed on computer 14-1. This logon webpage is not shown herein to avoid overcomplicating the herein disclosure. Reverse auction manager 24 also creates 100-2 a unique session id.

Reverse auction manager 24 enters 100-2 into a logon routine that includes an attempt to register user 18-1 if user 18-1 is a new user, or an attempt to authenticate user 18-1 as a valid user if user 18-1 has previously registered. If user 18-1 is unregistered, reverse auction manager 24 will attempt to generate a unique user id and obtain a user name, user contact information and password from user 18-1. The user id, user name, user contact information and user password are saved by reverse auction manager 24 in user database 30 in the respective fields of a new user record.

If user 18-1 is a previously registered user, then reverse auction manager will authenticate user 18-1 by querying user database 30 for the user record that corresponds to user 18-1 and comparing the user name and password entered by user 18-1 with the user name and password stored in the user record of user 18-1. After user 18-1 is successfully registered and authenticated, reverse auction manager 24 associates 100-6 the session id with the user id of user 18-1 by storing the session id in the user record associated with user 18-1.

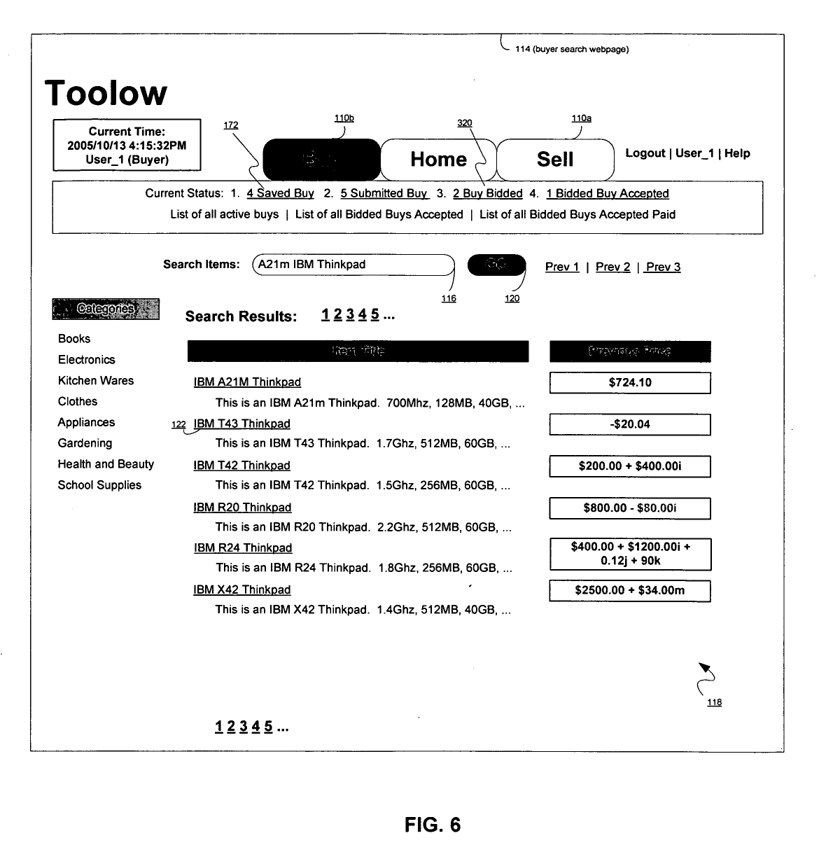

Reverse auction manager 24 also provides 100-8 a user interface to user 18-1 for enabling user 18-1 to search for buy transactions to submit for bid. This user interface is hereinafter referred to as a buyer-search user interface. Reverse auction manager 24 provides the buyer-search interface by transmitting it to computer 14-1 for display to user 18-1. With reference to FIG. 6, this buyer-search user interface may be in the form of a webpage 114 (“buyer-search webpage”). Buyer-search webpage 114 includes a search field 116, a search result area 118, and a search icon 120 for initiating a search using data entered into field 116, among other things. These fields are rendered empty or null by reverse auction manager 24 when it initially provides buyer-search webpage 114 to user 18-1.

To select an item for purchase, user 18-1 enters search terms that are relevant to the item sought by the user, in search field 116. If user 18-1 selects search icon 120 and using the search terms entered in search field 116, reverse auction manager performs 100-10 a search in catalog database 32 for item information found relevant to the entered search terms. The type of search algorithm is not intended to limit the present invention in any way. Any search algorithm may be used and is not disclosed to avoid overcomplicating the herein disclosure.

Upon completing its search algorithm, reverse auction manager 24 displays 100-12 the relevant item information in search result area 118 in the manner shown. The results displayed may include item information that were previously saved in catalog database 34 and that are respectively found by the search algorithm to be relevant to the search terms entered. For example, for item information found relevant, the item title, such as item title 122, brief item description and previous price paid, which may be in the form of the complex pricing format taught herein, may be displayed. User 18-1 may then review the item information returned by the search query and select an item title, such as item title 122, which describes an item that user 18-1 wishes to obtain or purchase through the reverse auction process.

In response to the selection of item title 122, reverse auction manager 24 provides buy transaction services as shown in FIG. 5 and which was briefly described above with respect to FIG. 3 in accordance with yet another embodiment of the present invention.

The selection of item title 122 causes reverse auction manager 24 to provide 104-2 a buy transaction user interface for defining the conditions, hereinafter referred to as “buy attribute values,” by which user 18-1 wishes to conduct a buy transaction for the item as described by item title 122 and by other corresponding item information that may be shown in search result area 118. This buy user interface may be implemented as a buy webpage 140, which is shown in FIG. 6 and which displays item title 122, an item id 142 and an item information 144 by using display fields 121, 143 and 145, respectively. Reverse auction manager 24 provides 104-2 buy webpage 140 by using item title 122 as a pointer or index to retrieve item id 142 and item information 144 from catalog database 32, by updating webpage 140 with this information as shown, and by sending the updated buy webpage 140 to web-enabled computer 14-1 for display to user 18-1.

The buy attribute values may be entered by user 18-1 using webpage 140 through various data fields, including drop-down menus, such as identity drop-down menu 146 and item condition drop-down menu 148, expiration period drop-down menu 150, delivery selection drop-down menu 152 and payment method drop-down menu 154; and input fields, such as quantity input field 156, a decrement input field 158 and an extra-condition input field 160.

Identity drop-down menu 146 permits user 18-1 to select whether to display the user's user id or keep it hidden when and if, user 18-1 submits the buy transaction for reverse auction bid. Item condition drop-down menu 148 permits user 18-1 to indicate whether the item selected is new or used. Item condition drop-down menu 148 is not applicable if the item selected for the buy transaction is a service rather than a good, and in such event, is grayed-out and rendered unusable by reverse auction manager 24.

Quantity input field 156 is used to receive from user 18-1 the quantity or units of the item selected for auction. Decrement input field 158 is used to receive from user 18-1 a minimum decrement amount that a seller bidding for the item must meet in order for the seller's bid to be considered a valid sell bid. This minimum decrement amount must comply with the complex price format disclosed herein. If left empty by user 18-1, reverse auction manager 24 will use a default value of “0” or null. Extra-condition input field 160 is a free-form field and is used to permit user 18-1 to enter additional buy transaction attribute values that are not available using the default input fields discussed above.

Expiration period drop-down menu 152 provides a set of expiration periods for the buy transaction, such as expiration periods of 1, 2 or 3 days, or 1 or 2 weeks. In this example, user 18-1 must select an expiration period. Otherwise, reverse auction manager 24 will return an error message on webpage 140 when user 18-1 selects save icon 168 or buy icon 170. This error message may be in a form requesting that user 18-1 select an auction expiration period.

Delivery selection field 154 provides a set of delivery period that may be selected by user 18-1, such as “Pick-Up” (the item or service is reasonably local to user 18-1), “Next Day”, “Second Day”, “Three Days”, “1 Week” and “2 Weeks”. Payment selection field 156 provides a set of payment choices that may be selected by user 18-1, including payment by credit card, third party on-line payment service provider, such as Paypal, or through the service provider providing reverse auction services through computer platform 10.

Webpage 140 may also further include a display field 166 for showing the posting charge for the buy transaction being defined as shown in webpage 140. For each buy transaction, the posting charge may be a fixed charge, or calculated by using the buy transaction attribute values entered by user 18-1 with the calculation performed by reverse auction manager 24. The method and variables used to calculate the posting charge is not intended to limit the various embodiments of the present invention in any way.

Once user 18-1 provides the desired buy transaction attribute values through buyer-bid webpage 140, user 18-1 has the option to process immediately or save these buy transaction attribute values by clicking on save icon 168 or buy icon 170, respectively. Selecting 104-4 save icon 168 causes reverse auction manager to save the buy transaction attribute values to the buy database 34 and to set a status indicator in status field, such as status field 80, to indicate that the buy attribute values pertain to a saved but not pending buy transaction. Saving these buy transaction attribute values allows user 18-1 to subsequently retrieve these buy transaction attribute values by selecting a saved buy icon, such as icon 172 on buyer-search webpage 114 in FIG. 6, or icon 174 on buy webpage 140 in FIG. 7. Reverse auction manager 24 responds to the selection icon 172 or icon 174 by opening a connection to buy database 34 and querying for any buy record having a status indicator that shows that the buy record has been saved by user 18-1 but is not yet pending. If so, reverse auction manager 23 causes these saved but not pending buy transactions to be transmitted to computer 14-1 for display to user 18-1.

Selecting 104-6 buy icon 170 will cause reverse auction manager 24 to create a buy transaction that has the buy transaction attribute values entered by user 18-1 on buy webpage 140. Reverse auction manager 24 creates this buy transaction when it generates a unique buy id for the buy transaction and saves the buy id, buy attribute values entered by user 18-1 on webpage 140 and user id of user 18-1 in a buy record, such as buy record 72-1, in buy database 34. Reverse auction manager also sets a status indicator in the status field, such as status field 80, in buy record 72-1 to indicate that the buy transaction values pertain to a pending buy transaction. The creation of the buy record in buy database 34 and the setting of the status indicator in status field 80 renders the buy transaction available for viewing not only by user 18-1 but by other users, such as user 18-2, that are searching for pending buy transactions until the reverse auction manager 24 clears status field 80. A buy transaction that is saved in buy database 34 in a buy record that has a status indicator of pending is hereinafter referred to as a “pending buy transaction”.

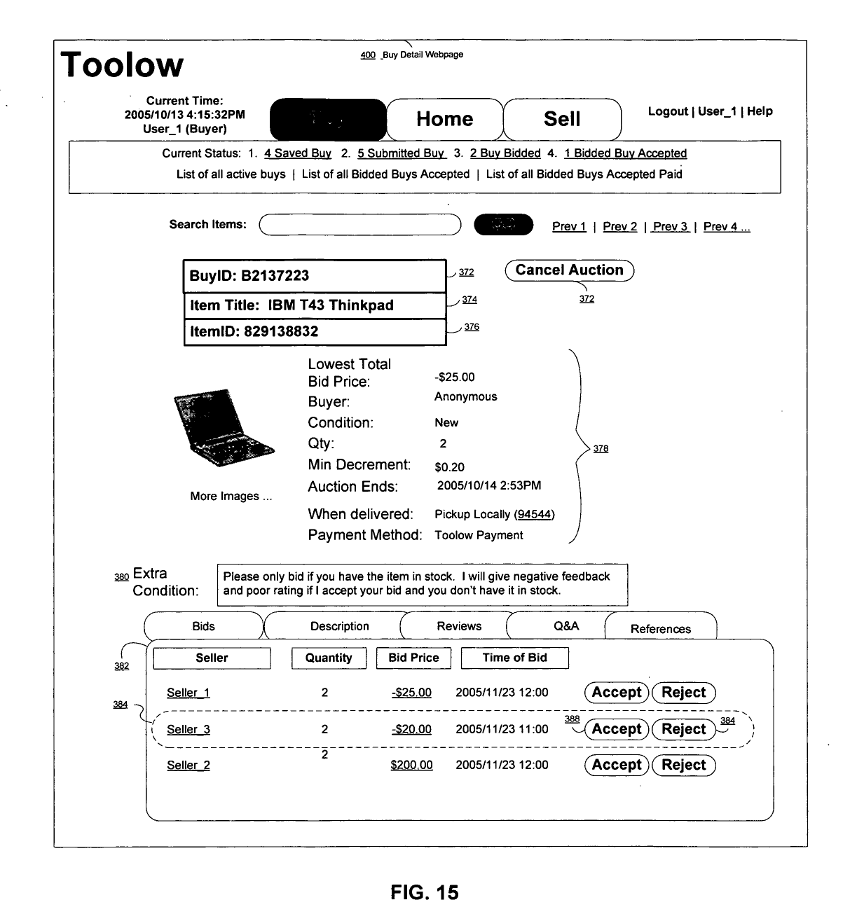

Reverse auction manager 24 changes the status indicator in status field 80 to expired if the auction period, which is one of the buy transaction attributes saved in buy record 72-1, expires before a bid is accepted by user 18-1. If user 18-1 cancels the buy transaction, then reverse auction manager 24 changes the status indicator to cancelled. If user 18-1 accepts a bid from another user, then reverse auction manager 24 changes the status indicator to accepted. Cancellation may be accomplished by using an icon on a selected user interface, such as cancel auction icon 372 which is implemented on webpage 400 shown in FIG. 15.

A buy record, which represents a buy transaction, that contains an expired, cancelled or accepted status indicator in its status field, such as status field 80, will not be available for bid. Hence, the reverse auction for the item subject to the pending buy transaction, in effect, also ends when the status indicator in status field 80 is set to expired, cancelled or accepted, whichever occurs first. Buy webpage 140 does not include a field for receiving a proposed buy price for the item subject to the buy transaction. Instead, a user, such as user 18-1, is not obligated to accept a bid, if any, from another user, such as user 18-2, for the item subject to the buy transaction. User 18-1 may cancel the pending buy transaction at any time even if valid bids have been received for the pending buy transaction.

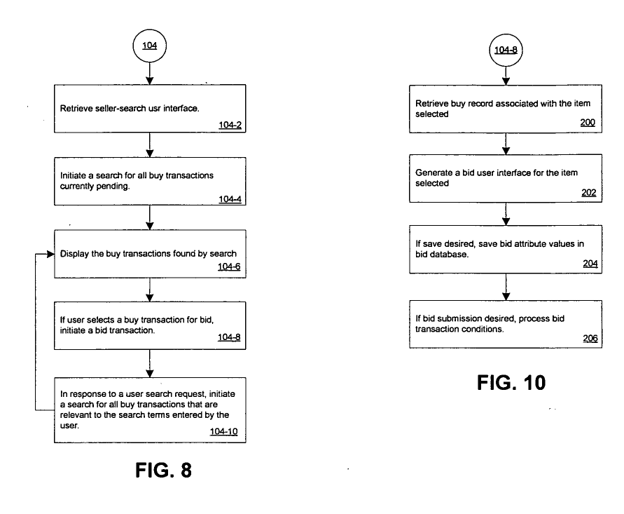

In block diagram form, FIG. 8 describes a process for performing 106 a sell transaction, which was briefly described above and in FIG. 3, in accordance with yet another embodiment of the present invention.

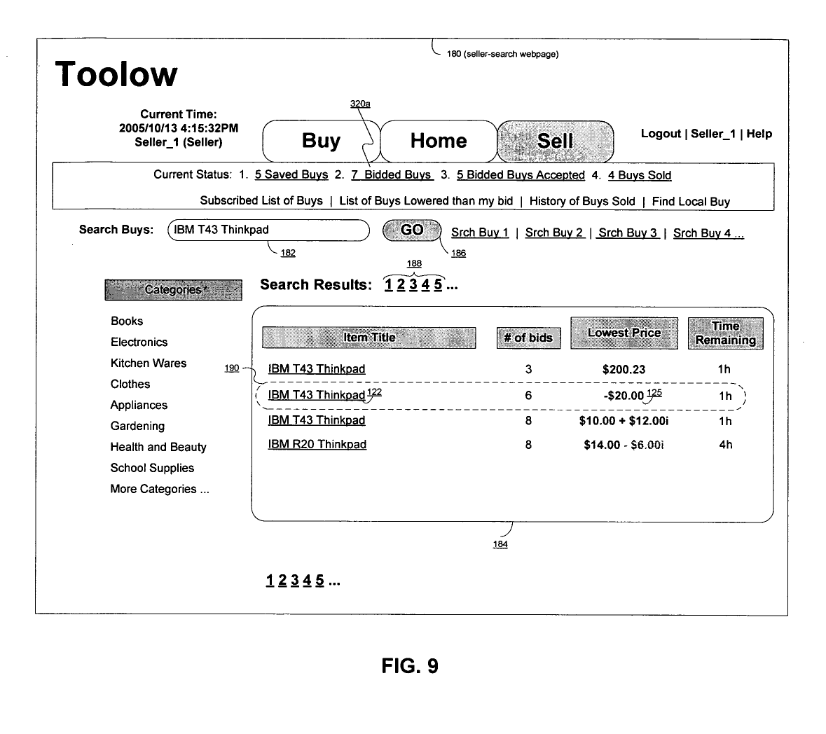

In response to another user, such as user 18-2, choosing to engage in a bid transaction, such as by selecting a sell icon 110a on webpage 114, reverse auction manager 24 retrieves 104-2 a seller-search user interface from a memory store, such as a hard disk drive, main memory or the like (not shown), initiates 104-4 a search for all pending buy transactions and displays 104-6 these pending buy transactions and by sending the seller-search user interface to web-enabled computer 14-1 for display to user 18-1. This seller-search user interface may be implemented in the form of a webpage 180, as shown in FIG. 9.

Webpage 180 includes a search field 182, a search result area 184, a search icon 186 for initiating a search using data entered in search field 182 by the user, and search-result page selection icons 188 for paging through search result area 184 if more than one page of search results are generated.

Reverse auction manager initiates the search for all pending buy transactions by opening a network connection to buy database 34, executing a query seeking all buy records that are stored in buy database 34 that have a status field, such as status field 80, containing a status indicator of pending, and by displaying the contents of selected fields defined in such buy records found. For example, as shown in FIG. 9, fields containing the item title, bid count, lowest total bid price for each buy record found are displayed in search result area 182. Thus, each pending buy transaction, such as pending buy transaction 190, is made viewable to user 18-2 by the display of the item title, such as item title 122, of the item subject to the pending buy transaction. If user 18-2 finds an item that the user wishes to sell or provide, user 18-2 may select that item to initiate 104-8 a bid transaction. In accordance with one embodiment of the present invention, the bid count reflects the number of bid records found, and the lowest total bid price reflects that lowest total bid price, such as lowest total bid price 125, found from the set of bid records found.

After viewing webpage 180 through the use of web-enabled computer 14-2, user 18-2 has the option of paging through each search page that contains pending buy transactions by using search-result page selection icons 188.

If user 18-2 does not select one of the displayed buy transactions, user 18-2 may search for an item to sell or provide by entering at least one search term into search field 182 and clicking on search icon 186 to initiate 104-10 a search using the data entered in search field 182. Clicking on search icon 186, causes reverse auction manager to initiate 104-10 a search routine by opening a network connection to buy database 34 and querying buy database 34 for any buy records that contain data relevant to the search term(s) entered in search field and that correspond have a status field, such as status field 80, that contains a status indicator of pending.

After the search is completed, program flow returns to 104-6, where reverse auction manager 24 displays 104-6 selected fields of the buy records found from the search by sending an updated version of webpage 180 that shows in search result area 184 selected field data associated with the buy records found. In effect, each row in search result area 184 represents a pending buy transaction, such as buy transaction 190, that is identified by using its corresponding item title, such as item title 122, and buy id. The buy id for each pending buy transaction is not displayed but tracked by reverse auction manger 24.

After these buy transactions are displayed, user 18-2 is not limited to selecting an item for a sell transaction or using the search feature, but may continue to browse for buy transactions, which may be displayed through item titles representing items subject to the buy transactions, by clicking on search result page selection numbers 186. This browsing function is not discussed to avoid over-complicating this disclosure.

In accordance with yet another embodiment of the present invention, FIG. 10 illustrates in block diagram form the process flow for initiating a bid transaction.

If user 18-2 selects a buy transaction, such as buy transaction 190, to sell or provide to another user, reverse auction manager 24 enters into the bid transaction routine by retrieving 200 the buy record associated with buy transaction 190 and by generating 202 a bid user interface for the item selected by user 18-2. Reverse auction manager obtains 24 retrieves the buy record by using the buy id associated with buy transaction 190. Bid user interface enables a seller, such as user 18-2, to review the buy attribute values defined for the selected item and if desired, to bid for the item selected (“bid user interface”) by defining conditions for the selected item, including a bid price that complies with the complex pricing format disclosed herein. The bid user interface may be implemented as a bid webpage 240, which is shown in FIG. 11.

Bid webpage 240 includes a variety of fields for displaying (“display fields”) the selected fields of the buy record associated with buy transaction. These fields may include a buy id display field 242 for displaying the buy id; an item title display field 244 for displaying the item title, such as item title 122; an item id field 246 for displaying the item id, such as item id 142.

Bid webpage 240 may also include a current bid field 248 for displaying the current lowest total bid price, such as lowest total bid price 125, submitted for the item described by item title 122. In accordance with one embodiment of the present invention, current lowest total bid price 249 may be displayable in the complex pricing format as taught in the various embodiments of the present invention disclosed herein.

Webpage 240 may also include additional display fields for displaying buy transaction attribute values that were previously saved in the buy record corresponding to buy transaction 190. These additional display fields include a buyer identity field 249 for displaying the identity of user 18-1 if user 18-1 had previously elected to place the bid with a buy transaction attribute value that the identity of user 18-1 may be displayed; a condition field 250 for displaying the condition of the item; a quantity field 251 for defining the number of items subject to the bid transaction, a decrement field 252 for displaying the minimum acceptable sell transaction bid price amount that may be included in a sell bid transaction; an auction expiration date 254 for the selected item, a deliver period field 256, payment field 258, an extra condition field 260 and an additional information area 262.

Reverse auction manager generates 202 webpage 240 by retrieving it from a memory store (not shown); retrieving the content for display fields 249 through 262 from buy database 34 and catalog database 32; placing the content in their respective fields; and sending updated webpage 240 to a web-enabled computer, such as computer 14-2, for display to user 18-2. In one embodiment of the present invention, reverse auction manager 24 obtains the buy attribute values displayed in fields 249 through 260 from the buy record having the buy id associated with buy transaction 190 and the item information displayed in field 262 from the item record corresponding to an item id, such as item id 142, obtained from the buy record having the buy id associated with buy transaction 190.

Webpage 240 may also include a bid attribute area 264, at least one bid icon, such as bid icons 266a or 266b, and a save icon 268. Bid attribute area 264 provides fields for entering the bid attribute values that will define the conditions that user 18-2 would be willing to sell buy transaction 190. These fields may include a bid price field 270 for entering the desired selling or providing price sought by user 18-2 for the selected item, taxes field 272, shipping and handling field 274, a field 276 for other charges, a total price field 278, and bid fee field 280. The desired selling or providing price entered in field 270 is limited to the complex pricing format herein described.

If desired, user 18-2 may save the bid transaction by selecting save icon 268, causing reverse auction manager to save information, such as the bid attribute values entered in bid attribute area 264, related to the bid transaction for buy transaction 190 in a bid record in bid database 36, permitting user 18-2 to subsequently retrieve the saved bid transaction by selecting a bidded buys icon, such as icon 280 on seller-search webpage 180 in FIG. 9, or icon 282 on bid webpage 240 in FIG. 11.

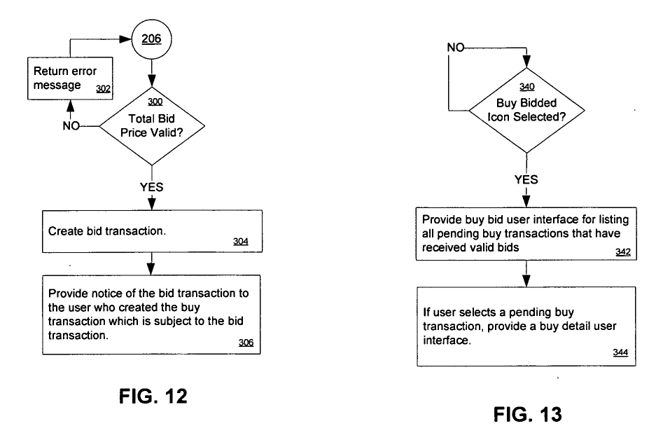

In the alternative, user 18-2 may submit a bid for buy transaction 190 by accepting the buy transactions displayed on webpage 240 and submitting through the selection of bid icon 266a or 266b the bid conditions entered in bid attribute area 262. In response, reverse auction manager 24 will process the bid as shown in FIG. 12.

In order for a bid to be accepted, user 18-2 must provide at least a proposed bid price value in bid price field 270, hereinafter the “proposed bid price”. In accordance with one embodiment of the present invention, this proposed bid price is checked by a program, such as java script (not shown), for a pricing format that complies with the complex pricing format that is within the scope and spirit of the complex pricing format taught herein. The java script program is provided as part of webpage 240 and executes on the computer, computer 14-2, used by user 18-2 to view webpage 240.

If taxes, shipping and handling, other charges or any combination of these costs have been entered by user 18-2, the java script program will add these costs with the proposed bid price entered in bid price field 270 and display their total value in total bid price field 278. This value calculated in total bid price field 278 is hereinafter the “proposed total bid price”. Once the total bid price is calculated, reverse auction manager 24 will calculate a value representing the fee for submitting the bid transaction and display this fee in posting fee field 280. The calculation of the fee may be performed after the calculation of the total value although this is not intended to be limiting in any way.

FIG. 12 is a block diagram describing a process for processing a bid transaction in a reverse auction in accordance with yet another embodiment of the present invention.

In response to user 18-2 selecting bid icon 266a or 266b, pricing manager 26 validates 300 the total bid price by performing the following. Pricing manager 26 queries bid database 36 for all bid records that correspond to the buy transaction selected for bid, which in this example is buy transaction 190. This search may be performed by querying for all bid records having a buy id that is equal to the buy id saved in the buy record of buy transaction 190.

For each bid record found, pricing manager 24 obtains the bid price and minimum decrement amount and forwards these values to pricing validator 28, which subtracts the minimum decrement amount from the bid price, creating a “net bid price”. Pricing valuator 28 compares the net bid price with the proposed total bid price. If the proposed total bid price is more than the net bid price, reverse auction manager 24 causes 302 an error message to be displayed to user 18-2.

If the proposed total bid price is less than or equal to the net bid price, then pricing manager 26 creates 304 a bid transaction that represents the bid entered in webpage 240 by user 18-2. For example, this bid transaction may be created by generating a bid id for the bid, causing the bid attribute values entered in webpage 240 and the buy id associated with buy transaction 190 to be stored in a bid record of bid database 36; and by causing a bid status indicator to reflect that the bid record contains fields that are displayable to all users, such as user 18-1 and 16-2. After the creation of the bid record, pricing manager 26 provides a completion status to reverse auction manager 24, which causes a notice to be sent to user 18-1 that a bid has been received for buy transaction 190.

In accordance with yet another embodiment of the present invention, FIG. 13 illustrates in block diagram form a process for accepting or rejecting a bid submitted for a buy transaction.

A user, such as user 18-1, who has previously submitted a buy transaction, such as buy transaction 190, has the option of reviewing the bid status for that buy transaction by selecting a buy bidded icon, such as buy bidded icon 320 in buyer search webpage 114, or buy bidded icon 322 in buy webpage 140. If user 18-1 selects a buy bidded icon, reverse auction manager 24 provides 342 a buyer bid user interface to user 18-1 by retrieving a buyer bid user interface from a memory store (not shown); populating the buyer bid user interface with information corresponding to pending buy transactions that have pending bids; and sending the buyer bid user interface to computer 14-1 for display to user 18-1.

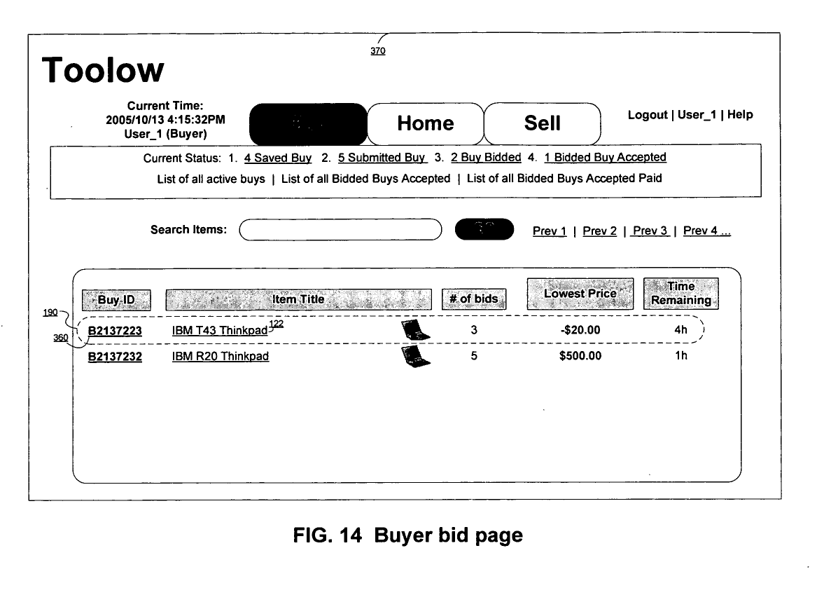

Buyer bid user interface enables a user, such as user 18-1, to review the user's pending buy transactions and to select any of these buy transactions to view, accept or reject the bid attribute values offered by another user for the selected buy transaction. In accordance with yet another embodiment of the present invention, the buyer bid user interface may be implemented as a buyer bid webpage 370, which is shown in FIG. 14.

Populating the buyer bid user interface includes searching for all pending buy records having a user id field containing the user id of user 18-1. For each pending buy record found, reverse auction manager 24: obtains a buy id, buy attribute values and an item id; searches bid database 36 for all bid records containing the buy id found; and searches catalog database 32 for an item record containing item id 120.

For each bid record found, reverse auction manager 24 displays the buy id, such as buy id 360, and the item title corresponding to the found bid record, such as item title 122, in a row representing a buy transaction previously created by user 18-1, such as buy transaction 190. The row may also include: the current number of bids submitted; the amount of time remaining; an item picture, if available, and the lowest total bid price submitted for buy transaction 190. The amount of time remaining is calculated using the expiration period obtained from the buy attribute values retrieved from the buy record, while the lowest total bid price is selected from one of the bid records found during the population of the buyer bid user interface above. The reverse auction manager 24 obtains the picture by searching catalog database 32 for a record containing item title 122, which as defined earlier, contains a field for storing item information, such as a picture.

If desired, user 18-1 may select a pending buy transaction, such as buy transaction 190, simply by clicking on the information displayed on the row, such as buy id 360 or item title 122, causing reverse auction manager 24 to provides a buy detail user interface for displaying of additional information pertaining to buy transaction 190. This buy detail user interface may be implemented in the form of a buy detail webpage 490, as shown in FIG. 15.

Buy detail webpage 400 includes the following display fields: a buy id field 372, item title field 372, item id field 374 for respectively displaying the buy id, item title, such as item title 122, and item id corresponding to the buy transaction selected above in webpage 370. Buy detail webpage also includes display fields for displaying the item information corresponding to the item id displayed in item id field 376. The item information is displayed in field area 378 and extra condition field 380.

Buy detail webpage 400 also includes a bid display area 382 for displaying bids received for buy transaction 190 as shown. Reverse auction manager 24 uses the bid id obtained above to search bid database 36 for bid records containing the bid. The selected information from each bid record found is then used to display information for each bid.

User 18-1 may then accept or reject a bid listed by selecting the corresponding accept or reject icon.

If user 18-1 selects a reject icon, such as reject icon 384, reverse auction manager will find the bid record associated with the bid selected for rejection, such as bid 384; change the bid status in the bid record to rejected, and then refresh the display of webpage 400. Refreshing the display of webpage 400 ensures that only bids that are still pending are displayed and thereby eliminating the display of rejected bid 384. Rejecting a bid does not end the reverse auction for buy transaction 190. User 18-1 may reject other bids and continue to receive subsequent bids while buy transaction remains pending.

User 18-1 may also select a bid to accept, such as bid 386, by selecting accept icon 388, causing reverse auction manager 24 to access the bid record associated with bid 386. Reverse auction manager 24 associates the bid id, which corresponds to the bid record, with the buy id corresponding to buy transaction 190, and changes the bid status in the bid record to a status of accepted, causing the reverse auction for buy transaction 190 to end. Reverse auction manager 24 may also send status messages to the user who accepted the bid, such as user 18-1, and the user whose bid was accepted. These messages may be in the form of email messages.

While the present invention has been described in particular embodiments, it should be appreciated that the present invention should not be construed as limited by such embodiments. Rather, the present invention should be construed according to the claims below.

What is claimed is:

1. A method for providing reverse auction services, the method comprising:
processing a logon request by a user;
if the user selects a buy transaction, providing a buy transaction service;
if the user selects a sell transaction, providing a sell transaction service; and
wherein said buy transaction service permits said user to submit a buy transaction without entering an initial bid price.

2. The method of claim 1, wherein said sell transaction service includes using a first user interface having a bid price field for receiving a pricing format that includes a non-realized value portion.

3. The method of claim 2, wherein said non-realized value portion includes a loan amount value.

4. The method of claim 3, wherein said non-realized value portion further includes an interest rate for said loan amount value.

5. The method of claim 3, wherein said non-realized value portion further includes a payment period for said loan amount value.

6. The method of claim 2, wherein said pricing format further includes a realized value portion.

7. The method of claim 6, wherein said realized value portion represents a currency value.

8. The method of claim 1, wherein:
said buy transaction service generates a pending buy transaction in response to a buy transaction request by said user; and
said user may cancel said pending buy transaction even if a valid bid is submitted for said pending buy transaction.

9. The method of claim 1, further including using a database to store item information for describing items available for said buy transaction.

10. A computer system for providing reverse auction services, comprising:
a reverse auction manager for managing reverse auction services provided by the computer system, said services including providing a buy transaction service; and
wherein, in response to a user requesting said buy transaction service, said reverse auction manager provides said buy transaction service to said user without requiring said user to enter an initial bid price.

11. The computer system of claim 10, wherein said service further includes providing a sell transaction service, said sell transaction service includes providing a first user interface having a bid price field for receiving a pricing format that includes a non-realized value portion.

12. The computer system of claim 11, wherein said pricing format further includes a realized value portion.

13. The computer system of claim 10, wherein:
said buy transaction service includes a first user interface for submitting a pending buy transaction which may be canceled by said user even if a valid bid is submitted for said pending buy transaction.

14. The computer system of claim 10, further including a database to store item information for describing items which may be subject to said buy transaction service.

15. A computer system for providing reverse auction services, comprising:
a reverse auction manager for processing respectively logon requests by a first user and a second user, for providing a buy transaction service if said first user requests a buy transaction, and for providing a sell transaction service if said second user selects a sell transaction;
a pricing manager for reviewing a proposed bid price entered by a second user in response to a pending buy transaction and for ensuring said proposed bid price complies with a selected pricing format;
a pricing validator for determining whether said proposed bid price is less than or equal to the total of a previously entered bid price for said pending buy transaction minus any decrement value; and
wherein, in response to said selection of said buy transaction service by said first user, said reverse auction manager generates a first user interface that does not include an initial bid price field when generating a pending buy transaction.

16. The computer system of claim 15, wherein said pending buy transaction may be canceled by said first user even if said pricing validator deems said proposed bid price valid.

17. The computer system of claim 15, further including a database to store item information for describing items which may be subject to said buy transaction service.

18. A computer system for providing reverse auction services, comprising:
a means for managing reverse auction services provided by the computer system, said services including providing a buy transaction service; and
wherein, in response to a user requesting a buy transaction service, said means for managing provides said buy transaction service to said user without requiring said user to enter an initial bid price.

19. The computer system of claim 18, wherein said service further includes providing a sell transaction service, said sell transaction service for providing a first interface means having a bid price field for receiving a pricing format that includes a non-realized value portion.

20. The computer system of claim 19, wherein said pricing format further includes a realized value portion.

21. The computer system of claim 18, wherein:
said buy transaction service includes a first interface means for submitting a pending buy transaction which may be canceled by said user even if a valid bid is submitted for said pending buy transaction.

22. The computer system of claim 18, further including a means for storing item information, said item information for describing items which may be subject to said buy transaction service.

23. A method for providing reverse auction services, the method comprising:
processing a logon request by a user;
if the user selects a buy transaction, providing a buy transaction service; and
wherein said buy transaction service permits said user to submit a buy transaction without entering an initial bid price.

24. The method of claim 23, further including, if the user selects a sell transaction, providing a sell transaction service;

25. The method of claim 24, wherein said sell transaction service includes using a first user interface having a bid price field for receiving a pricing format that includes a non-realized value portion.

26. The method of claim 25, wherein said pricing format further includes a realized value portion.

27. The method of claim 23, wherein:
said buy transaction service generates a pending buy transaction in response to buy transaction request by said user; and
said user may cancel said pending buy transaction even if a valid bid is submitted for said pending buy transaction.
